(19) United States
(12) Patent Application Publication
(10) Pub. No.: US 2023/0195770 A1
(43) Pub. Date: Jun. 22, 2023

(54) Method for Classifying Asset File

(71) Applicant: TMAXSOFT CO., LTD., Gyeonggi-do (KR)

(72) Inventors: Wooseok JUNG, Gyeonggi-do (KR); Eungkyu LEE, Gyeonggi-do (KR)

(73) Assignee: TMAXSOFT CO., LTD., Gyeonggi-do (KR)

(21) Appl. No.: 18/076,202

(22) Filed: Dec. 6, 2022

(30) Foreign Application Priority Data
Dec. 20, 2021 (KR) 10-2021-0182528

(51) Int. Cl. G06F 16/35; G06F 40/284

(52) U.S. Cl. CPC G06F 16/35; G06F 40/284

(57) ABSTRACT

According to an exemplary embodiment of the present disclosure, a method for classifying an asset file performed by a computing device including at least one processor is disclosed. The method for classifying an asset file includes generating input data used for a classification model by performing preprocess on a first asset file in a partitioned data set (PDS) unit; generating a classification result obtained by classifying the first asset file from the input data using the classification model; and classifying the first asset file based on the classification result.

### CROSS-REFERENCE TO RELATED APPLICATIONS

This application claims priority to and the benefit of Korean Patent Application No. 10-2021-0182528 filed in the Korean Intellectual Property Office on Dec. 20, 2021, the entire contents of which are incorporated herein by reference.

### TECHNICAL FIELD

The present disclosure relates to a method for classifying an asset file, and more particularly, to a method for automatically classifying an asset file of a user in a mainframe.

### BACKGROUND ART

A mainframe may be a large general purpose computing device which is capable of processing a variety of data. The mainframe used for general purpose may accommodate all kinds of tasks in various fields such as financial, manufacturing, and public sectors. The mainframe stores data for tasks in various fields so that there is a necessity to classify received asset files of customers. Here, the asset file may be a data set which is determined by the customers to have meaningful values. The asset file may be an application or a program determined by the customers to have meaningful values. A processing or operating method of the data may vary depending on a technical field related to the asset file so that the mainframe has a necessity to classify the received asset files of the customers.

However, in the related art, a technology for classifying the asset files has not been developed so that when it is necessary to classify the asset files, a manager needs to manually and directly identify and classify the asset files. In addition, the asset files have various and non-uniform file formats so that the manager needs to directly unify the file formats. Accordingly, a lot of time and efforts are necessary to classify the asset files. Further, the results of classifying the asset files are not consistent so that there is a problem in that the reliability is not guaranteed.

### RELATED ART DOCUMENT

Patent Document

(Patent Document 1) Japanese Patent Application Laid-Open No. 2003-153564 (May 29, 2003)

### SUMMARY OF THE INVENTION

The present disclosure has been made in an effort to correspond to the above-described background art and an object is to provide a method for classifying asset files with a high accuracy for a classification result.

Technical objects of the present disclosure are not limited to the aforementioned technical objects and another technical objects which are not mentioned will be apparently appreciated by those skilled art from the following description.

In order to achieve the above-described objects, according to an aspect of the present disclosure, a method for classifying an asset file which is performed by a computing device including at least one processor is disclosed. The method for classifying an asset file includes generating input data used for a classification model by performing preprocess on a first asset file in a partitioned data set (PDS) unit; generating a classification result obtained by classifying the first asset file from the input data using the classification model; and classifying the first asset file based on the classification result.

The generating of input data to be used for a classification model by performing preprocess on a first asset file in a partitioned data set (PDS) unit includes dividing the first asset file in the partitioned data set unit into source files in a member unit; tokenizing a text included in the source file; and generating the input data by vectorizing the tokenized source file.

The generating of the input data by vectorizing the tokenized source file includes: generating the input data by vectorizing the source file according to a term frequency-inverse document frequency (TF-IDF) technique which uses an importance level of a word included in the source file.

The dividing of the first asset file in the partitioned data set unit into source files in a member unit includes checking whether a plurality of source codes included in the first asset file exists in a directory form; when the plurality of source codes exists in a directory form, dividing the first asset file into the source file in the member unit; and dividing the first asset file into the source file in the member unit based on delimiter information in which the plurality of source codes is divided when the plurality of source codes does not exist in the directory form.

The dividing of the first asset file in the partitioned data set unit into source files in a member unit includes converting the first asset file into American standard code for information interchange (ASCII) data format when the first asset file is an extended binary coded decimal interchange code (EBCDIC) data format; and dividing the converted first asset file in the partitioned data set unit into source files in a member unit.

The converting of the first asset file into American standard code for information interchange (ASCII) data format when the first asset file is an extended binary coded decimal interchange code (EBCDIC) data format includes: when there is a unrecognizable source code in the source code included in the first asset file with the EBCDIC data format, converting the source code into the ASCII data format based on a CPM file indicating a language used to generate the first asset file.

The classification model is trained in advance using structured data generated based on a feature extracted from the asset file.

The classification model generates the classification result based on a probability that the first asset file corresponds to any one label among a plurality of previously defined labels.

The classification result includes information about a result of classifying the first asset file into any one label among a plurality of previously defined labels or information about a result that the first asset file is not classified into previously defined labels.

The method may further include: determining a distribution chart in which at least two features are distributed in the first asset file when it is determined that there are at least two features in the first asset file after generating the classification result; determining one first feature based on the distribution charts of at least two features; and regenerating the classification result based on the one first feature.

The method may further include storing the generated classification result in the database as a table.

A computing device for classifying an asset file includes a processor which generates input data used for a classification model by performing preprocess on a first asset file in a partitioned data set (PDS) unit, generates a classification result obtained by classifying the first asset file from the input data using the classification model; and classifies the first asset file based on the classification result.

A computer program stored in a computer readable storage medium, wherein when the computer program is executed by one or more processors, the computer program performs the following method to classify the asset file, and the method includes: the generating of input data to be used for a classification model by performing preprocess on a first asset file in a partitioned data set (PDS) unit; generating a classification result obtained by classifying the first asset file from the input data using the classification model; and classifying the first asset file based on the classification result.

A technical object to be achieved from the present disclosure is not limited to the aforementioned technical objects, and another not-mentioned technical object will be obviously understood by those skilled in the art from the description below.

According to some exemplary embodiments of the present disclosure, a method for classifying asset files with a high accuracy for a classification result may be provided.

Effects to be achieved in the present disclosure are not limited to the aforementioned effects, and another not-mentioned effects will be obviously understood by those skilled in the art from the description below.

### BRIEF DESCRIPTION OF THE DRAWINGS

Various aspects will be described with reference to the drawings and like reference numerals collectively designate like elements. In the following exemplary embodiments, a plurality of specific details will be suggested for more understanding of one or more aspects for the purpose of description. However, it will be apparent that the aspect(s) will be embodied without having the specific details. In other examples, known structures and devices will be illustrated as a block diagram to easily describe the one or more aspects.

FIG. 1 is a block diagram for explaining an example of a computing device according to some exemplary embodiments of the present disclosure;

FIG. 2 is a flowchart for explaining an example of a method for classifying asset files by a computing device according to some exemplary embodiment of the present disclosure;

FIG. 3 is a flowchart for explaining an example of a method for pre-processing asset files by a computing device according to some exemplary embodiment of the present disclosure;

FIG. 4 is a flowchart for explaining an example of a method for dividing asset files into source files by a computing device according to some exemplary embodiment of the present disclosure;

FIG. 5 is a flowchart for explaining an example of a method for generating a classification result based on a distribution chart by a classification model according to some exemplary embodiments of the present disclosure; and

FIG. 6 illustrates a general schematic view of an exemplary computing environment in which exemplary embodiments of the present disclosure are embodied.

### DETAILED DESCRIPTION

Various exemplary embodiments and/or aspects will be disclosed with reference to the drawings. For the purpose of description, in the following description, various specific details will be disclosed for more understanding of one or more aspects. Those skilled in the art may recognize that the aspect(s) may be embodied without the specific details. The following description and accompanying drawings describe specific exemplary aspects of one or more aspects in detail. However, the aspects are illustrative and a part of the various methods of the principles of the various aspects may be used and the description is intended to include all the aspects and equivalents thereof. Specifically, “exemplary embodiments”, “examples”, “aspects”, and “illustrative embodiment” used in the present specification may not be interpreted such that a described arbitrary aspect or design is better than other aspects or designs or has advantages.

Hereinafter, regardless of the reference numerals, the same or like component is denoted by the same or like reference numeral and a redundant description thereof will be omitted. In describing the exemplary embodiment disclosed in the present specification, when it is determined that a detailed description of a related publicly known technology may obscure the gist of the exemplary embodiment disclosed in the present specification, the detailed description thereof will be omitted. Further, the accompanying drawings are provided for better understanding of the exemplary embodiment disclosed in the present specification so that the technical spirit disclosed in the present specification is not limited by the accompanying drawings.

Although the terms “first”, “second”, and the like are used for describing various elements or components, these elements or components are not confined by these terms. These terms are merely used for distinguishing one element or component from the other elements or components. Therefore, a first element or component to be mentioned below may be a second element or component in a technical concept of the present disclosure.

Unless otherwise defined, all terms (including technical and scientific terms) used in the present specification may be used as the meaning which may be commonly understood by the person with ordinary skill in the art, to which the present disclosure belongs. It will be further understood that terms defined in commonly used dictionaries should not be interpreted in an idealized or excessive sense unless expressly and specifically defined.

The term “or” is intended to refer to not exclusive “or”, but inclusive “or”. That is, when it is not specified otherwise or is unclear in the context, “X uses A or B” is intended to mean one of natural inclusive substitutions. That is, when X uses A; X uses B; or X uses both A and B, “X uses A or B” may be applied to any of the above instances. Further, it should be understood that the term “and/or” used in this specification designates and includes all available combinations of one or more items among listed related items.

Even though the term “include” and/or “including” means the presence of the corresponding feature and/or component, it should be understood that the term “include” and/or “including” does not preclude existence or addition of one or more other features, components and/or these groups. Further, when it is not separately specified or it is not clear from the context to indicate a singular form, the singular form in the specification and the claims is generally interpreted to represent “one or more”.

Terms used in the present specification, “information” and “data” may be interchangeably used, frequently.

It should be understood that, when it is described that a component is “coupled” or “connected” to another component, the component may be directly coupled or directly connected to the other component or coupled or connected to the other component through a third component. In contrast, when it is described that a component is “directly coupled” or “directly connected” to another component, it should be understood that no component is present therebetween.

Suffixes such as “module” and “unit” for components used in the following description are given or mixed and used by considering easiness in preparing the specification and do not have a meaning or role distinguished from each other in themselves.

Objects, effects, and technical components for achieving the objects and effects will be clear by referring to exemplary embodiments described below in detail together with the accompanying drawings. In the following description of the present disclosure, a detailed description of known functions or configurations or functions incorporated herein will be omitted when it is determined that the detailed description thereof may make the subject matter of the present disclosure unclear. Further, the terms to be described below are defined considering the functions in the present disclosure and may vary depending on the intention or usual practice of a user or operator.

However, the present disclosure is not limited to embodiments disclosed below and may be implemented in various forms. Only the exemplary embodiments are provided so that the present disclosure is complete, and to fully inform those of ordinary skill in the art to which the present disclosure belongs, the scope of the disclosure, and the present disclosure is only defined by the scope of the claims. Accordingly, the terms need to be defined based on details throughout this specification.

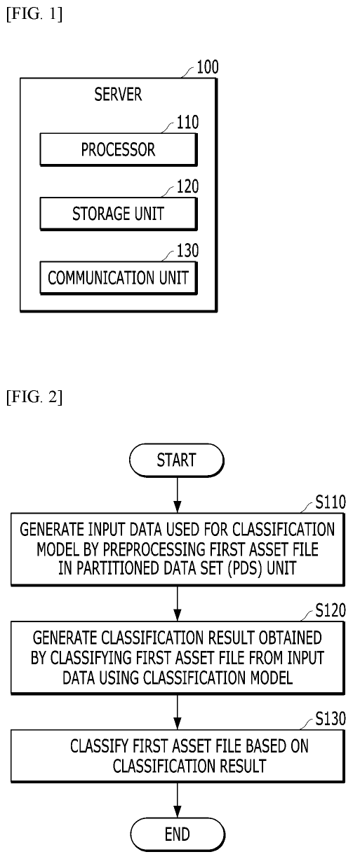

In the present disclosure, the computing device may classify asset files in the partitioned data set (PDS) unit. The asset file may be a data set received from the customer. The asset file may be an application or a program received from the customer. The partitioned data set may be a data set including a plurality of members. The member may be an individual component which configures one class in the object oriented programming. The member unit may indicate a source file unit. The member may include a separate sub-data set. The partitioned data set may have the same or similar structure to a directory structure for classifying files. This kind of partitioned data set may be used to store an execution program, a source program, a library, or a task control language. Asset files of the partitioned data set unit may have very diverse and different formats. Accordingly, the computing device may preprocess the asset files. The computing device inputs input data generated by preprocessing the asset file to a classification model to classify the asset files. Here, the classification model may be a neural network based model. Hereinafter, a method for classifying asset files performed by the computing device according to the present disclosure will be described with reference to FIGS. 1 to 6.

FIG. 1 is a block diagram for explaining an example of a computing device according to some exemplary embodiments of the present disclosure.

Referring to FIG. 1, the computing device 100 in the present disclosure includes a processor 110, a storage unit 120, and a communication unit 130. However, the above-mentioned components are not essential for implementing the computing device 100 so that the computing device 100 may include more components or less components than the above-described components.

The computing device 100, for example, includes an arbitrary type of computer system or computer device such as a microprocessor, a main frame computer, a digital processor, a portable device, and a device controller.

The processor 110 controls the overall operation of the computing device 100. The processor 110 may process a signal, data, or information which is input or output through the above-described components of the computing device 100 or drives the application programs stored in the memory to provide or process appropriate information or functions.

The processor 110 may be configured by one or more cores and may include a processor for data analysis, such as a central processing unit (CPU) of a computing device 100, a general purpose graphics processing unit (GPGPU), and a tensor processing unit (TPU).

In the present disclosure, the processor 110 preprocesses a first asset file in a partitioned data set unit to generate input data to be used for the classification model. The classification model generates a classification result obtained by classifying the first asset file from the input data. The processor 110 classifies the first asset file based on the classification result output by means of the classification model.

The classification model may be a neural network based model. The neural network may generally be configured by a set of interconnected calculating units which may be referred to as “nodes”. The “nodes” may also be referred to as “neurons”. The neural network is configured to include at least one node. The nodes (or neurons) which configure the neural networks may be connected to each other by one or more “links”.

In the neural network, one or more nodes connected through the link may relatively form a relationship of an input node and an output node. Concepts of the input node and the output node are relative so that an arbitrary node which serves as an output node with respect to one node may also serve as an input node with respect to the other node and vice versa. As described above, an input node to output node relationship may be created with respect to the link. One or more output nodes may be connected to one input node through the link and vice versa. In the input node and output node relationship connected through one link, a value of the output node may be determined based on data input to the input node. The node which connects the input node and the output node to each other may have a weight.

The weight may be variable and may vary by the user or the algorithm to allow the neural network to perform a desired function.

For example, when one or more input nodes are connected to one output node by each link, the output node may determine an output node value based on values input to the input nodes connected to the output node and a weight set to the link corresponding to the input nodes. As described above, in the neural network, one or more nodes are connected to each other through one or more links to form an input node and output node relationship in the neural network.

In the neural network, a characteristic of the neural network may be determined in accordance with the number of the nodes and links and a correlation between the nodes and links, and a value of the weight assigned to the links.

For example, when there are two neural networks in which the same number of nodes and links are provided and weights value between links are different, it may be recognized that the two neural networks are different. The neural network may be configured to include one or more nodes. Some of the nodes which configure the neural network may configure one layer based on distances from an initial input node.

For example, a set of nodes with a distance n from the initial input node may configure n layers. The distance from the initial input node may be defined by a minimum number of links which needs to go through to reach from the initial input node to the corresponding node.

However, the definition of the layer is arbitrary provided for description and the dimensionality of the layer in the neural network may be defined differently from the above description.

For example, the layer of the nodes may be defined by a distance from the finally output node. The initial input node may refer to one or more nodes to which data is directly input without passing through the link in the relationship with other nodes, among the nodes in the neural network.

Alternatively, in the neural network, in the relationship between nodes with respect to the link, the initial input node may refer to nodes which do not have other input nodes linked by the link.

Similarly, the final output node may refer to one or more nodes which do not have an output node, in the relationship with other nodes, among the nodes in the neural network.

A hidden node may refer to nodes which configure the neural network, other than the initial input node and the finally output node.

In the neural network according to some exemplary embodiments of the present disclosure, the number of nodes of the input layer may be equal to the number of nodes of the output layer and the number of nodes is reduced and then increased from the input layer to the hidden layer.

In the neural network according to another exemplary embodiment of the present disclosure, the number of nodes of the input layer may be smaller than the number of nodes of the output layer and the number of nodes is reduced from the input layer to the hidden layer.

In the neural network according to some exemplary embodiments of the present disclosure, the number of nodes of the input layer may be larger than the number of nodes of the output layer and the number of nodes is increased from the input layer to the hidden layer.

The neural network according to another exemplary embodiment of the present disclosure may be a neural network obtained by the combination of the above-described neural networks.

A deep neural network (DNN) may refer to a neural network including a plurality of hidden layers in addition to the input layer and the output layer.

When the deep neural network is used, latent structures of the data may be identified. That is, it is possible to identify latent structures of photos, texts, video, audio, and music (for example, which objects are in the photo, what is the content and the emotion of the text, and what is the content and the emotion of the audio).

The deep neural network may include a convolutional neural network (CNN), a recurrent neural network (RNN), auto encoder, a generative adversarial network (GAN), a restricted boltzmann machine (RBM), a deep belief network (DBN), a Q network, a U network, a Siamese network, or a backbone network.

Description of the above-described deep neural networks is only an example and the present disclosure is not limited thereto. The neural network may be trained by at least one of supervised learning, unsupervised learning, and semi supervised learning methods.

The learning of the neural network is to minimize an error of the output. Training data is repeatedly input to the neural network during the learning of the neural network, an output of the neural network for the training data and an error of the target are calculated, and an error of the neural network is back-propagated from the output layer of the neural network to the input layer direction so as to reduce the error to update a weight of each node of the neural network.

In the case of the supervised learning, training data (that is, labeled training data) labeled with a correct answer is used for each training data, but in the case of the unsupervised learning, the correct answer may not be labeled to each training data.

That is, for example, the training data of the supervised learning for data classification may be training data labeled with category. The labeled training data is input to the neural network and the error may be calculated by comparing the output (category) of the neural network and the label of the training data.

As another example, in the case of the unsupervised learning for data classification, an error may be calculated by comparing the training data which is an input with the neural network output. The calculated error is backpropagated to a reverse direction (that is, a direction from the output layer to the input layer) in the neural network and a connection weight of each node of each layer of the neural network may be updated in accordance with the backpropagation. A variation of the connection weight of the nodes to be updated may vary depending on a learning rate. The calculation of the neural network for the input data and the backpropagation of the error may configure a learning epoch.

The learning rate may be differently applied depending on the repetitive number of the learning epochs of the neural network. For example, at the beginning of the neural network learning, the neural network quickly ensures a predetermined level of performance using a high learning rate to increase efficiency and at the late stage of the learning, the low learning rate is used to increase the precision. In the learning of the neural network, normally, the training data may be a sub set of the actual data (that is, data to be processed using the learned neural network). Therefore, there may be a learning epoch that the error of the training data is reduced and the error is increased for the actual data.

The overfitting is a phenomenon in which the training data is excessively learned so that an error for actual data is increased. For example, a phenomenon that a neural network that learns a cat by showing a yellow cat does not recognize a cat other than the yellow cat as a cat may be a type of overfitting. The overfitting may act as a cause of the increase of the error of the machine learning algorithm. In order to prevent the overfitting, various optimization method may be used. In order to prevent the overfitting, a method of increasing training data, regularization, or dropout which omits some nodes of the network during the learning process may be applied.

The storage unit 120 may include a memory and/or a permanent storage medium. The memory may include at least one type of storage medium of flash memory type, hard disk type, multimedia card micro type, and card type memories (for example, SD or XD memory and the like), a random access memory (RAM), a static random access memory (SRAM), a read only memory (ROM), an electrically erasable programmable read only memory (EEPROM), a programmable read only memory (PROM), a magnetic memory, a magnetic disk, and an optical disk.

The storage unit 120 stores an arbitrary type of information which is generated or determined by the processor 110 and an arbitrary type of information received by the communication unit 130. In the present disclosure, the storage unit 120 may store the first asset file in the partitioned data set unit. The storage unit 120 may store a classification result for the first asset file generated by the classification model in the database as a table.

The communication unit 130 includes one or more modules which enable communication between the computing device 100 and a communication system or between the computing device 100 and a network. The communication unit 130 may include at least one of a wired internet module and a wireless internet module.

Hereinafter, a method for classifying asset files by a computing device according to the present disclosure will be described.

FIG. 2 is a flowchart for explaining an example of a method for classifying asset files by a computing device according to some exemplary embodiment of the present disclosure.

Referring to FIG. 2, the processor 110 of the computing device 100 preprocesses a first asset file in a partitioned data set unit to generate input data to be used for the classification model in step S110.

The partitioned data et may be a data set including a plurality of members. The member may be an individual component which configures one class in the object oriented programming. The member may include a separate sub-data set. The partitioned data set may have a structure which is the same as or similar to a directory structure for classifying files. The classification model may not use the first asset file in the partitioned data set unit as an input value. An input value used for the neural network model such as a classification model may be generally data with a matrix structure. Accordingly, the processor 110 may preprocess the first asset file in the partitioned data set unit to perform the cleansing in the unit of members.

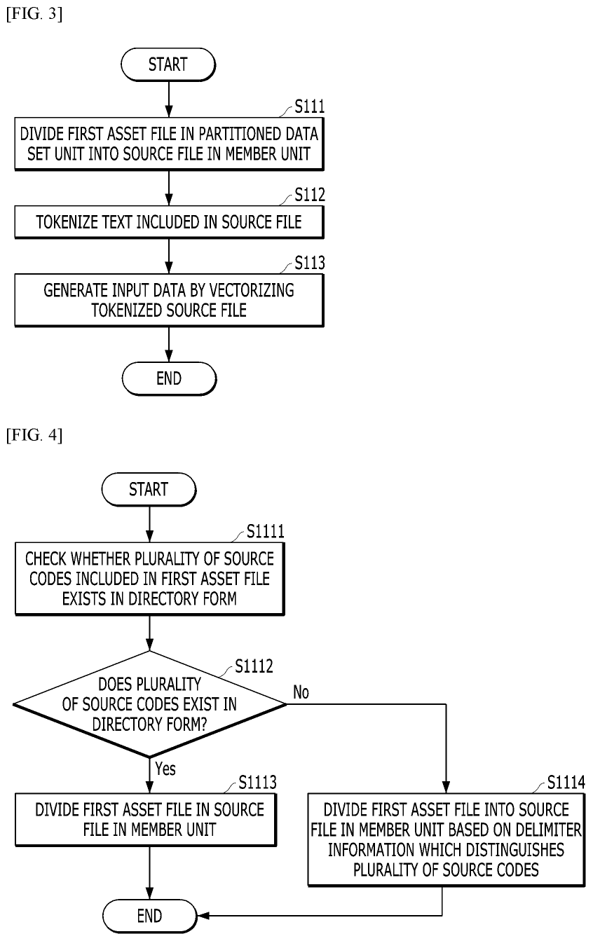

The preprocessing may be an operation to allow the first asset file to be used as an input value for the classification model. The preprocessing may be an operation of vectorizing a source file included in the first asset file. Vectorization may be an operation of converting a text included in the source file into a column vector. The processor 110 vectorizes the source file included in the first asset file to generate input data. Hereinafter, an example of a method for preprocessing the first asset file in the partitioned data set unit by the processor 110 will be described with reference to FIG. 3.

The processor 110 generates a classification result obtained by classifying the first asset file from the input data using the classification model in step S120.

Specifically, the classification model may generate a classification result based on a probability that the first asset file corresponds to any one label among a plurality of previously defined labels stored in the storage unit 120. The label may indicate a category in which various types of asset files are classified by an administrator. The classification model may calculate a probability that the first asset file corresponds to the plurality of previously defined labels stored in the storage unit 120. The classification model may determine any one label corresponding with a highest probability among the plurality of labels. The classification model may generate a classification result based on the determined label. When the classification result is generated, the storage unit 120 may store the generated classification result in the database as a table.

According to some exemplary embodiments of the present disclosure, the classification result includes information about a result of classifying the first asset file to any one label among the plurality of previously defined labels or information about a result that the first asset file is not classified to the previously defined label. In other words, when the first asset file is not classified to the previously defined label, the classification model may generate a classification result indicating that the first asset file is not classified. When the classification result that the first asset file is not classified is generated, the processor 110 provides a reanalysis function to allow the customer to directly determine the first asset file. For example, the reanalysis function may be a function which requires a feedback for the first asset file.

In some exemplary embodiments of the present disclosure, there may be at least two features in the first asset file. When there are at least two features in the first asset file, the classification model generates the classification result based on a distribution chart in which each feature is distributed in the first asset file. Hereinafter, a method for generating a classification result based on the distribution chart by the classification model will be described with reference to FIG. 5.

According to some exemplary embodiments of the present disclosure, the classification model may be a model which is trained in advance using structured data generated based on a feature extracted from the asset file. The structured data may be data whose meaning is identified only by numerical values or a text, among data input according to a predetermined rule of the database. As the classification model is trained in advance using the structured data, the accuracy for the classification result of classifying the first asset file by the classification model may be improved.

The processor 110 may classify the first asset file based on the classification result in step S130. According to the exemplary embodiment, when the first asset file is classified by the processor 110, the storage unit 120 may store the generated classification result in the database as a table. The classification result stored in the database as a table may be utilized for the classification model to classify the second asset file later.

With the above-described configuration, the computing device 100 may classify the first asset file in the partitioned data set unit using the classification model. In the related art, a technique for a preprocessing operation of a file in the partitioned data set unit has not been developed or may be incomplete. Accordingly, the administrator needs to manually cleanse the asset file of the partitioned data set unit in the unit of members first to classify the asset files. Accordingly, a lot of time and efforts were consumed for the cleansing of the asset file by the administrator. In contrast, the computing device 100 according to the present disclosure preprocesses the asset file in the partitioned data set unit to generate input data used for the classification model. In addition, according to the present disclosure, the asset file is classified using the classification model so that the consistency for the classification result may be high.

Hereinafter, a method for preprocessing an asset file by the computing device 100 according to the present disclosure will be described.

FIG. 3 is a flowchart for explaining an example of a method for pre-processing asset files by a computing device according to some exemplary embodiment of the present disclosure.

Referring to FIG. 3, the processor 110 of the computing device 100 divides a first asset file in a partitioned data set unit into source files in the member unit in step S111. The member unit may indicate a source file unit. The source file may be a text file that describes the computer program by a human readable programming language. The processor 110 may divide the first asset file in the partition data set unit including a plurality of members into source files in the member unit.

According to some exemplary embodiments of the present disclosure, when the first asset file is an extended binary coded decimal interchange code (EBCDIC) data format, the processor 110 may convert the first asset file into an American standard code for information interchange (ASCII) data format. The EBCDIC data format is an extended binary coded decimal interchange code and is mainly an 8-bit encoding code system used for the IBM main frame operating system. The ASCII data format is a standard code for information exchange between data processing and communication system established by American Standards Association and may be a 7-bit encoding code system. According to the exemplary embodiment, even though the first asset file is data having a format other than the EBCDIC data format, the processor 110 converts the first asset file into the ASCII data format. In other words, even though a first asset file may be any type, the processor 110 may convert the first asset file into the ASCII data format. Accordingly, the processor 110 may divide the converted first asset file in the partitioned data set unit into the source file in the unit of members.

When there is a source code which is not recognizable, among source codes included in the first asset file in the EBCDIC data format, the processor 110 may convert the source code into the ASCII data format based on a code page map file (CPM) which represents a language used to generate the first asset file. The CPM file may be a file which represents a language used to generate the first asset file by the administrator. For example, the processor 110 may not recognize special characters of the source code included in the first asset file. The processor 110 may convert the source code created with the special character into the ASCII data format based on the CPM file. Accordingly, even though there is an unrecognizable source code in the source code included in the first asset file, the processor 110 may convert the source code into the ASCII data format.

The processor 110 may tokenize the text included in the source file in step S112. The tokenization may be a task which separates a text according to a symbol indicating the end of a sentence, such as a period (.), an exclamation point (!), a question mark (?) of a sentence. The tokenization may be a task of separating the text with respect to the spacing. Further, the processor 110 tokenizes the first asset file to remove the annotation, substitute a special character, delete the spacing, or unify upper and lower case letters.

The processor 110 vectorizes the tokenized source file to generate input data in step S113. Vectorization may be an operation of converting a text included in the source file in to a column vector.

Specifically, the processor 110 vectorizes the source file according to a term frequency-inverse document frequency (TF-IDF) technique which uses the importance level of a word included in the source file to generate the input data. TF-IDF technique is a technique which uses a term frequency and an inverse document frequency to apply a weight to the importance level of each word in the document-term matrix (DTM). Here, the inverse document frequency may be a value indicating how much one text commonly appears in the entire set of documents. The processor 110 may generate the input data obtained by vectorizing the source file based on the importance level of each text included in the source file according to the TF-IDF technique. When the input data is generated, the processor 110 generates a classification result obtained by classifying the first asset file from the input data using the classification model. Accordingly, the classification result may be a result in which the importance levels of the texts included in the first asset file are also considered.

According to the above-described configuration, the computing device 100 may divide the asset file in the partitioned data set unit into source files in the member unit. The computing device 100 tokenizes the text included in the source file and vectorizes the tokenized source file to generate input data. The input data is data obtained by vectorizing the source file so that the input data may be used as an input value of the classification model. In the related art, a technique of creating the asset file in the partitioned data set unit into vectorized data to be input to the classification model has not been developed or incomplete. Accordingly, the administrator needs to manually cleanse the asset file. In contrast, the computing device 100 according to the present disclosure performs input data to be used for the classification model from the asset file in the partitioned data set unit by means of the above-described method. Accordingly, the administrator does not need to manually cleanse the asset file in the partitioned data set unit.

According to some exemplary embodiments of the present disclosure, the computing device 100 may divide the asset file into source files in the member unit based on whether a plurality of source codes included in the asset file is present as a directory form. Hereinafter, a method for dividing asset files into source files by the computing device 100 according to the present disclosure will be described.

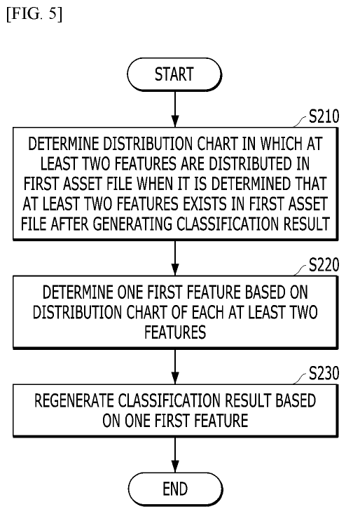

FIG. 4 is a flowchart for explaining an example of a method for dividing asset files into source files by a computing device according to some exemplary embodiment of the present disclosure.

Referring to FIG. 4, the processor 110 of the computing device 100 identifies whether the plurality of source codes included in the first asset file is present as a directory form in step S1111. The directory form may be a form of a hierarchical tree structure in which subdirectories exist based on a root directory.

When the plurality of source codes exists in the directory form (Yes in S1112), the processor 110 divides the first asset file into source files in the member unit in step S1113. When the plurality of source codes exists in the directory form, it is understood that a plurality of source codes individually exists. Alternatively, when the plurality of source codes exists in the directory form, it is understood that source files included in the first asset file individually exit in the directory form. Accordingly, when the plurality of source codes included in the first asset file exists in the directory form, the processor 110 divides the first asset file into the source files in the member unit without requiring additional information.

When the plurality of source codes does not exist in the directory form (No in S1112), the processor 110 divides the first asset file into source files in the member unit based on delimiter information in which the plurality of source codes is distinguished in step S1114. The delimiter information may refer to a delimiter or an array of characters used to delimit a boundary between separate independent areas in the text or a data stream. The delimiter may be, for example, a comma (,) or a spacing. When the plurality of source codes does not exist in the directory form, it is understood that a plurality of source codes does not individually exist. In other words, when the plurality of source codes does not exist in the directory form, it is understood that a plurality of source codes exists as one source file. When the plurality of source codes does not exist in the directory form, but is present in one source file, the processor 110 divides the first asset file into source files in the member unit based on delimiter information.

According to the above-described configuration, the computing device 100 may divide the first asset file into source files in the member unit regardless of whether a plurality of source codes included in the first asset file is present as a directory form. In other words, the computing device 100 may divide the first asset file into source files in the member unit even though a plurality of source codes included in the first asset file exists in any format. Accordingly, the computing device 100 may generate input data used for the classification model using source files which are divided in the member unit.

In some exemplary embodiments of the present disclosure, there may be at least two features in the first asset file. When there are at least two features in the first asset file, the classification model generates the classification result based on a distribution chart in which each feature is distributed in the first asset file. Hereinafter, a method for generating a classification result based on a distribution chart by the classification model will be described.

FIG. 5 is a flowchart for explaining an example of a method for generating a classifying result based on a distribution chart by a classification model according to some exemplary embodiments of the present disclosure.

Referring to FIG. 5, when it is determined that there are at least two features in the first asset file after generating the classification result, the classification model may determine a distribution chart in which at least two features are distributed in the first asset file in step S210. The distribution chart may be a value or a numerical value representing how much at least two features are distributed in the first asset file.

According to an exemplary embodiment, the classification model may determine a feature in the first asset file based on a predetermined threshold. When the classification result is generated, the classification model determines a plurality of preliminary features in the first asset file. The classification model may determine a feature which is equal to or higher than the predetermined threshold, among the plurality of preliminary features. When there are at least two features which are equal to or higher than the predetermined threshold, the classification model determines a distribution chart in which at least two features are distributed in the first asset file.

The classification model may determine one first feature based on the distribution charts of at least two features in step S220. For example, the classification model may determine one feature having a higher distribution chart among at least two features as a first feature. When the distribution charts for the first feature is high, it is understood that the first asset files are distributed in the first asset file more than the second file.

The classification model may regenerate a classification result based on the one first feature in step S210. For example, the classification model regenerates a classification result based on a probability corresponding to any one label, among a plurality of labels in which the determined first feature is previously defined. Accordingly, the accuracy for the classification result generated by the classification model may be improved.

According to the above-described configuration, the classification model may determine whether there are at least two features in the first asset file after generating the classification result. When here are at least two features in the first asset file, the classification model regenerates a classification result based on the distribution chart of each feature. Accordingly, the accuracy for the classification result generated by the classification model may be improved.

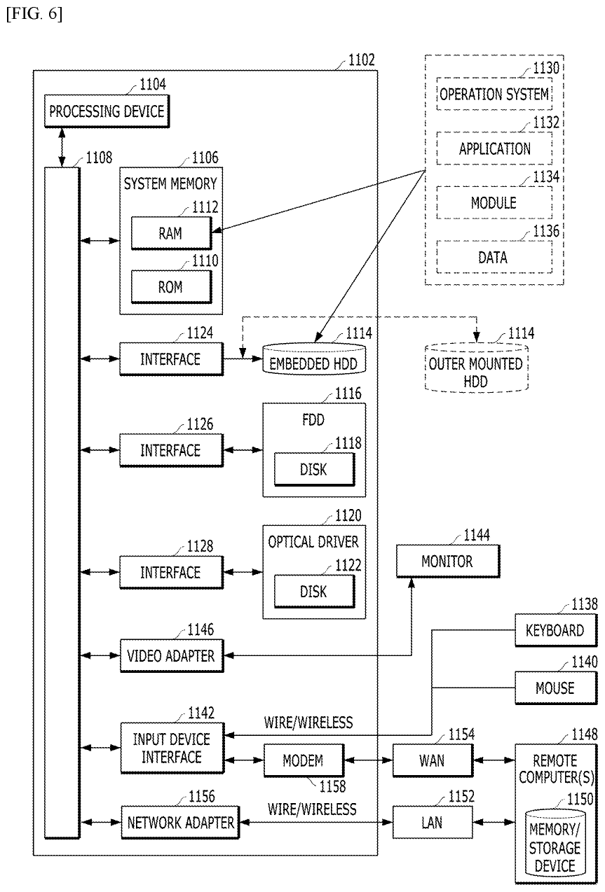

FIG. 6 is a simple and general schematic diagram illustrating an example of a computing environment in which the exemplary embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA)) — the embedded HDD 1114 being configured for exterior mounted usage within a proper chassis (not illustrated) - a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an exterior mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

Description of the suggested exemplary embodiment is provided to allow those skilled in the art to use or embody the present disclosure. Various modifications of the exemplary embodiments may be apparent to those skilled in the art and general principles defined herein may be applied to other exemplary embodiments without departing from the scope of the present disclosure. Therefore, the present disclosure is not limited to the exemplary embodiments suggested herein, but interpreted in the broadest range which is consistent with principles suggested herein and new features.

What is claimed is:

1. A method for classifying an asset file which is performed by a computing device including at least one processor, the method comprising:
generating input data to be used for a classification model by performing preprocess on a first asset file in a partitioned data set (PDS) unit;
generating a classification result obtained by classifying the first asset file from the input data using the classification model; and
classifying the first asset file based on the classification result.

2. The method according to claim 1, wherein the generating of input data to be used for a classification model by performing preprocess on a first asset file in a partitioned data set (PDS) unit includes:
dividing the first asset file in the partitioned data set unit into source files in a member unit;
tokenizing a text included in the source file; and
generating the input data by vectorizing the tokenized source file.

3. The method according to claim 2, wherein the generating of the input data by vectorizing the tokenized source file includes:
generating the input data by vectorizing the source file according to a term frequency-inverse document frequency (TF-IDF) technique which uses an importance level of a word included in the source file.

4. The method according to claim 2, wherein the dividing of the first asset file in the partitioned data set unit into source files in a member unit includes:
checking whether a plurality of source codes included in the first asset file exists in a directory form;
when the plurality of source codes exists in a directory form, dividing the first asset file into the source file in the member unit; and
dividing the first asset file into the source file in the member unit based on delimiter information in which the plurality of source codes is divided when the plurality of source codes does not exist in the directory form.

5. The method according to claim 2, wherein the dividing of the first asset file in the partitioned data set unit into source files in a member unit includes:
converting the first asset file into American standard code for information interchange (ASCII) data format when the first asset file is an extended binary coded decimal interchange code (EBCDIC) data format; and
dividing the converted first asset file in the partitioned data set unit into source files in a member unit.

6. The method according to claim 5, wherein the converting of the first asset file into American standard code for information interchange (ASCII) data format when the first asset file is an extended binary coded decimal interchange code (EBCDIC) data format includes:
when there is an unrecognizable source code in the source code included in the first asset file with the EBCDIC data format, converting the source code into the ASCII data format based on a CPM file indicating a language used to generate the first asset file.

7. The method according to claim 1, wherein the classification model is trained in advance using structured data generated based on a feature extracted from the asset file.

8. The method according to claim 1, wherein the classification model generates the classification result based on a probability that the first asset file corresponds to any one label among a plurality of previously defined labels.

9. The method according to claim 8, wherein the classification result includes information about a result of classifying the first asset file into any one label among a plurality of previously defined labels or information about a result that the first asset file is not classified into previously defined labels.

10. The method according to claim 1, further comprising:
determining a distribution chart in which at least two features are distributed in the first asset file when it is determined that there are at least two features in the first asset file after generating the classification result;
determining one first feature based on the distribution charts of at least two features; and
regenerating the classification result based on the one first feature.

11. The method according to claim 1, further comprising:
storing the generated classification result in a database as a table.

12. A computing device for classifying an asset file, comprising:
a processor which generates input data used for a classification model by performing preprocess on a first asset file in a partitioned data set (PDS) unit, generates a classification result obtained by classifying the first asset file from the input data using the classification model; and classifies the first asset file based on the classification result.

13. A computer program stored in a computer readable storage medium, wherein when the computer program is executed by one or more processors, the computer program performs the following method to classify the asset file, the method including:
generating input data used for a classification model by performing preprocess on a first asset file in a partitioned data set (PDS) unit;
generating a classification result obtained by classifying the first asset file from the input data using the classification model; and
classifying the first asset file based on the classification result.
